(19) United States
(12) Patent Application Publication
(10) Pub. No.: US 2022/0076308 A1
(43) Pub. Date: Mar. 10, 2022

(54) SYSTEMS AND METHODS FOR SELECTIVELY AUTHORIZING TRANSACTIONS IN ONLINE COMMERCE BASED ON DYNAMICALLY-DETERMINED SALES REGIONS

(71) Applicant: SHOPIFY INC., Ottawa (CA)

(72) Inventor: CHRISTIAN ZACHARIAS, BERLIN (DE)

(21) Appl. No.: 17/016,619

(22) Filed: Sep. 10, 2020

(51) Int. Cl. G06Q 30/06; G06Q 30/02

(52) U.S. Cl. CPC G06Q 30/0607; G06Q 30/0639; G06Q 30/0201; G06Q 30/0222; G06Q 30/0641

(57) ABSTRACT

E-commerce and online shopping may allow a merchant to have a geographically diverse and rapidly changing customer base. This makes monitoring and tracking the customer base of a merchant a challenge. Embodiments of the present disclosure provide computer-implemented systems and methods for dynamically defining one or more sales regions for a product sold online by a merchant. These sales regions may define, at least in part, the customer base of the merchant. According to one embodiment, a computer-implemented method includes obtaining multiple e-commerce data records for a product offered for sale in a first online store, where each data record pertains to at least one geographic location. The method further includes dynamically defining a sales region based on the multiple e-commerce data records. The sales region includes geographic locations that meet at least one defined condition for the product.

### FIELD

The present application relates to authorization and authentication of transactions, and in particular embodiments, to, dependent on geographic constraints, selectively providing access to product listings and selectively authorizing purchase transactions in online/electronic commerce.

### BACKGROUND

E-commerce and online shopping have allowed merchants to expand their businesses beyond the physical locations of brick-and-mortar retail stores. Many merchants are now able to reach geographically diverse customer bases through their online stores. However, monitoring and tracking these customer bases over time remains a challenge.

### SUMMARY

Some embodiments of the present disclosure provide computer-implemented systems and methods to determine an online customer base or online “sales region” for a merchant's product using e-commerce data. This sales region may he defined in terms of the geographic locations of the merchant's customers and optionally in terms of customer demographic (for example, age and/or gender). By virtue of online shopping, the sales region for the merchant may be geographically diverse and changing dynamically. Using e-commerce data to determine the sales region may accommodate for this diverse and dynamic nature of online shopping.

Furthermore, the computer-implemented systems and methods provided herein may perform additional automated operations using a determined sales region for a merchant. An example of such operations is dynamically determining the resale merchants that are permitted to purchase a product from the merchant and/or dynamically determining the customers that are permitted to purchase the product from the resale merchant. Based on such a determination, a determination may be made as to whether or not to present particular products for purchase by a given resale merchant and/to authorize purchase transactions by that merchant. Put another way, a determination of an online sales region may be made which may then constrain whether or not a given resale merchant will be allowed to purchase particular products and/or to limit the products that a given resale merchant is allowed to purchase.

According to an aspect of the present disclosure, there is provided a computer-implemented method including obtaining multiple e-commerce data records for a product offered for sale in a first online store, where each data record may pertain to at least one geographic location. Each of the e-commerce data records may relate to at least one of sales of the product, advertisement of the product, and online store traffic associated with the product. The method also includes dynamically defining a region based on the multiple e-commerce data records. The region may include geographic locations that meet at least one defined condition for the product. The method may further include outputting content to a device associated with a second online store. This content may be based on the region.

In some embodiments, dynamically defining the region includes dynamically defining boundaries of the region to include the geographic locations that meet the at least one defined condition for the product and optionally to exclude other geographic locations that do not meet the at least one defined condition for the product.

In some embodiments, obtaining the multiple e-commerce data records includes obtaining the e-commerce data records at different times. In these embodiments, dynamically defining the boundaries of the region may include updating the boundaries of the region responsive to obtaining the multiple e-commerce data records.

In some embodiments, the method further includes dynamically defining a plurality of regions, including the region, based on the multiple e-commerce data records. The content may be further based on the plurality of regions. In the case that the multiple e-commerce data records are obtained at different times, dynamically defining the plurality of regions may include adjusting a number of regions in the plurality of regions responsive to obtaining the multiple e-commerce data records.

In some embodiments, the device is associated with a merchant of the second online store and the content may include an indication that sales of the product to customers located in the region are restricted.

In some embodiments, the device is associated with a customer of the second online store. In these embodiments, the method may further include obtaining, via the device, an indication that the customer is interested in purchasing the product from the second online store and/or determining that the device is located within the region. Dynamically defining the region may be done responsive to obtaining the indication. In some embodiments, outputting the content to the device may include restricting sales of the product to the customer. Restricting the sales of the product to the customer may include generating the content to include an offer for sale of one or more other products excluding the product. The restricting may be performed responsive to determining that the device is located within the region.

In some embodiments, the device is associated with a merchant of the second online store and outputting the content to the device includes identifying one or more sales regions associated with the second online store and/or determining that the one or more sales regions do not include the region. Outputting the content may be done responsive to obtaining a request via the device and the content may comprise an option for the merchant of the second online store to purchase the product from a merchant of the first online store for resale outside of the region.

According to another aspect of the present disclosure, there is provided a system including a memory to store e-commerce data records, and one or more processors to perform any method as disclosed herein.

According to a further aspect of the present disclosure, there is provided a non-transitory computer readable medium storing computer executable instructions which, when executed by a computer, cause the computer to perform any method disclosed herein.

### BRIEF DESCRIPTION OF THE DRAWINGS

Embodiments will be described, by way of example only, with reference to the accompanying figures wherein:

FIG. 1 is a block diagram of an e-commerce platform, according to one embodiment;

FIG. 2 is an example of a home page of an administrator, according to one embodiment;

FIG. 3 illustrates the e-commerce platform of FIG. 1, but including a sales region engine;

FIG. 4 is a map illustrating multiple sales regions for a particular product sold through an online store by a merchant, according to an embodiment;

FIG. 5 is a block diagram illustrating a system for defining sales regions, according to an embodiment;

FIG. 6 illustrates a data structure for storing multiple e-commerce data records, according to an embodiment;

FIG. 7 is a flow diagram illustrating a method for dynamically defining one or more sales regions for a product, according to an embodiment;

FIG. 8 is a map illustrating multiple sales regions for a particular product sold through an online store by an original merchant at a first instance in time, according to an embodiment;

FIG. 9 is a map illustrating the sales regions of FIG. 8 at a second instance in time;

FIG. 10 illustrates a screen page displayed on a customer device that is in a location shown in FIG. 8 at the first instance in time;

FIG. 11 illustrates a screen page displayed on another customer device that is in another location shown in FIG. 8 at the first instance in time;

FIG. 12 illustrates another screen page displayed on the customer device of FIG. 11 at the second instance in time;

FIG. 13 is a map illustrating the sales regions of FIG. 8 at the first instance in time and sales regions of a resale merchant at the first instance in time; and

FIG. 14 illustrates a resale merchant device displaying a screen page corresponding to a business-to-business (B2B) wholesale marketplace.

### DETAILED DESCRIPTION

For illustrative purposes, specific example embodiments will now be explained in greater detail below in conjunction with the figures.

### Example E-commerce Platform

In some embodiments, the methods disclosed herein may be performed on or in association with a commerce platform, which will be referred to herein as an e-commerce platform. Therefore, an example of an e-commerce platform will be described.

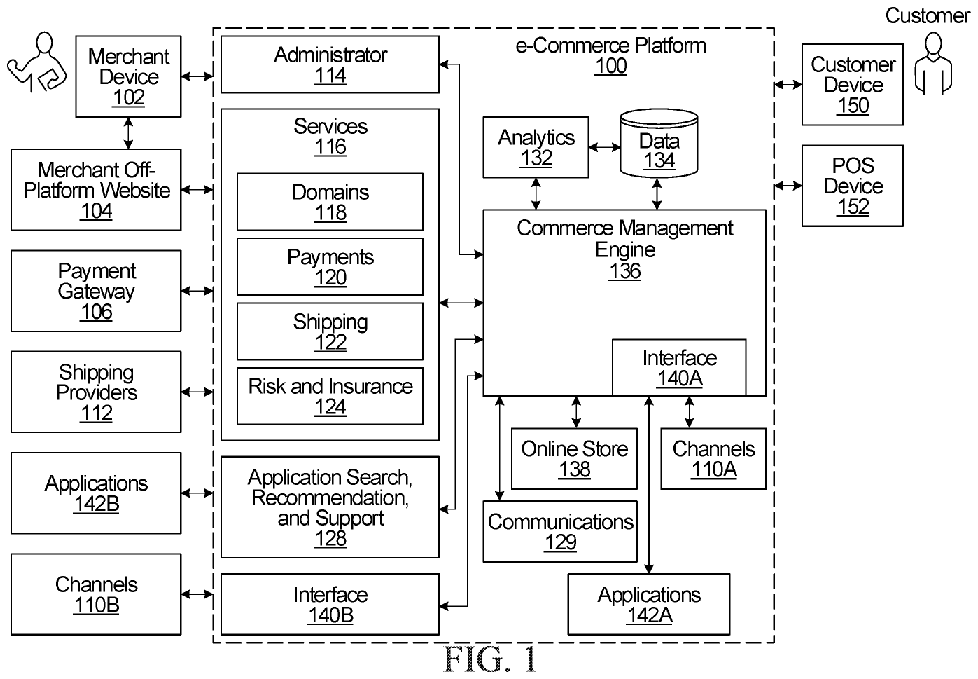

FIG. 1 illustrates an e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next, A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

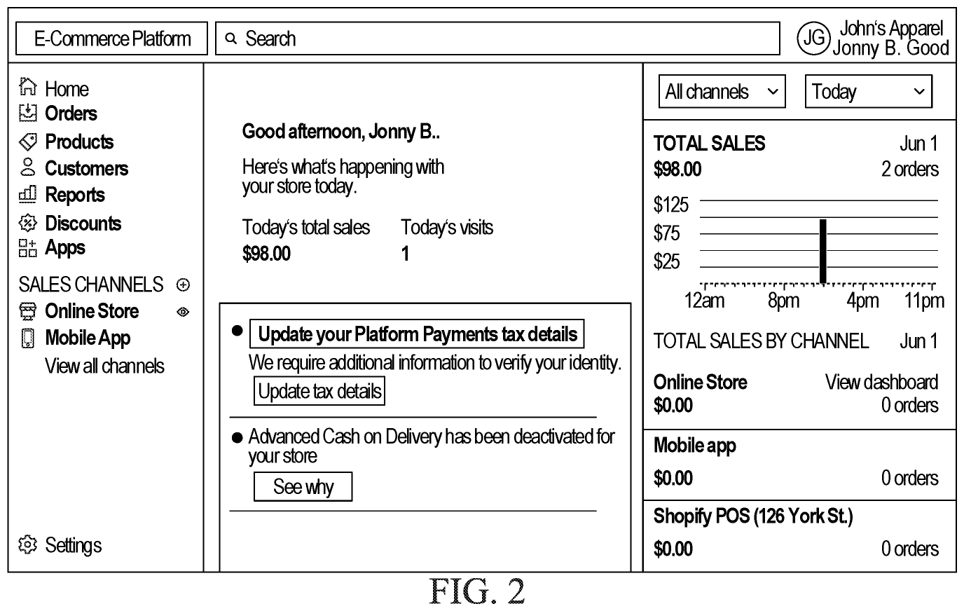

FIG. 2 depicts a non-limiting embodiment for a home page of an administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A. may be provided by the same party providing the platform 100 or by a different party. In some embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 14213 and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may he items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Product Resale in an E-commerce Platform

In order to expand into new markets, merchants may sell their products at wholesale prices to resale merchants with different customer bases. For example, a resale merchant may operate in (and be established in) different geographic locations than an original merchant. After purchasing the original merchant's products, the resale merchant may then resell the products to customers in these different geographic locations. An advantage of this practice is that the resale merchant may access markets that the original merchant might not have access to. The act of one merchant selling their products to another merchant at wholesale prices is referred to as business-to-business (B2B) wholesale

In B2B wholesale selling, there is a risk that a resale merchant will market and/or sell a product to the same customer base as the original merchant. By way of example, the original merchant may target a product at a particular customer base and may even invest in advertising to increase sales within this customer base. If a resale merchant is permitted to purchase the product from the original merchant and resell the product to this customer base, then the original merchant may experience reduced direct sales with the customer base, resulting in reduced profits. The original merchant would only gain the wholesale price of the product that the resale merchant paid, rather than the full price of the product that a customer may have potentially paid. Furthermore, any advertising that the original merchant invested in to increase sales within the customer base may be underutilized.

Accordingly, an original merchant of a product may want to restrict which customers could purchase the product through a resale merchant. This may include restricting the customers that a resale merchant may sell a product to and/or restricting the resale merchants that are permitted to purchase the product at a wholesale price. For example, any resale merchants that target the same customer base as the original merchant may be restricted from reselling the product to that customer base or may be restricted from purchasing the product from the original merchant at all. In some cases, implementing such restrictions requires knowledge of the original merchant's customer base and, optionally, knowledge of the resale merchant's customer base.

For conventional merchants that utilize brick-and-mortar retail stores, a customer base may be determined based on the physical locations of the retail stores. For example, the customer base of a retail store may include the customers that live close enough to travel to the retail store. The customer bases of multiple retail stores owned or otherwise utilized by the merchant may be combined to define an overall customer base for the merchant. The number and locations of brick-and-mortar retail stores, and their respective customer bases, do not typically change at a rapid rate. This may allow the merchant to relatively easily track the locations of their customer base.

However, as outlined above, many merchants now implement online shopping, either exclusively or in combination with brick-and-mortar retail stores. Online shopping may raise technical challenges to determining the location of a customer base for a merchant. Through an online store, customers (who may be anywhere in the world) may potentially purchase products from a merchant who may be anywhere in the world or may even be virtual (i.e., have only an online and no physical presence). There are few limitations that restrict the locations where customers may purchase products from the merchant. For example, a merchant based in the U.S. might have a strong customer base in Iceland that purchases products from the merchant's online store. As such, when a merchant sells a product online, the customer base for the product is in no way limited to a particular physical location. Instead, the location of a customer base for the product might be dependent on other factors, including the regional popularity (e.g., product sales, page views, social media shares), advertising spend and/or shipping costs for the product in various locations, for example.

The location of a customer base for a product sold via an online store may also change rapidly. For example, the regional popularity, advertising budget, and/or shipping costs for the product in various locations may change rapidly, potentially resulting in corresponding changes in the customer base for the product. In one example, the popularity of a product might rapidly grow or decline in a particular region based on customer trends. In another example, an online advertising budget may be rapidly reallocated to target different locations and/or customer demographics. In a further example, shipping costs for a particular location may be rapidly reduced by the merchant utilizing a dropshipping supplier in the location, possibly resulting in increased product sales for that region.

Accordingly, a need exists for computer-implemented systems and methods to enable a merchant that is selling their product online (using the e-commerce platform 100, for example) to restrict resale of the product to their online customer base or particular portions thereof. These computer-implemented systems and methods should account for the geographic flexibility and rapid changes in the customer base that are enabled through online shopping.

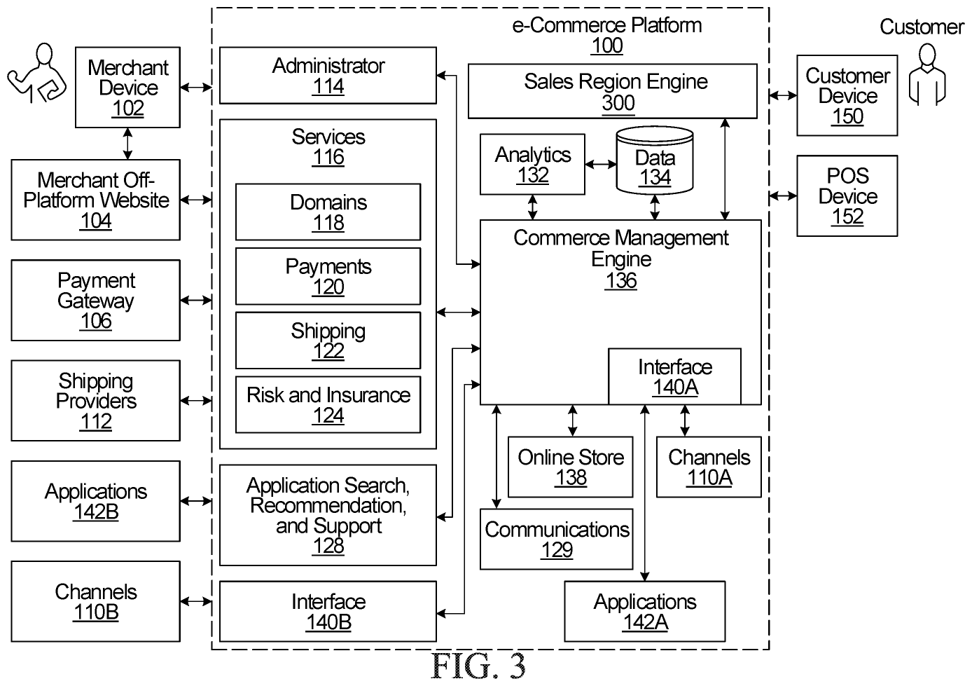

FIG. 3 illustrates the e-commerce platform 100 of FIG. 1, but including a sales region engine 300. The sales region engine 300 is an example of a computer-implemented system for using e-commerce data to dynamically define one or more sales regions for a product sold online by a merchant. A sales region generally includes a set of one or more geographic locations that contain current and/or potential customers for a merchant and/or a product sold by the merchant. In other words, a sales region may define, at least in part, the customer base of a merchant. In some implementations, a merchant's sales regions are used to define areas where sale of any, one, some or all of the merchant's products are restricted by resale merchants. As such, only the original merchant of those products may benefit from sale of their products in these areas.

More broadly, dynamically defined sales regions may also be used for applications other than restricting the resale of a product to an original merchant's customer base. For example, the original merchant might, additionally or alternatively, use the sales regions to observe gaps in their customer base. The original merchant may then invest in new retail stores and/or advertising to help fill the gaps in their customer base.

Although the sales region engine 300 is illustrated as a distinct component of the e-commerce platform 100 in FIG. 3, this is only an example. A sales region engine could also or instead be provided by another component of the e-commerce platform 100 or offered as a stand-alone component or service that is external to the platform 100. In some embodiments, the commerce management engine 136 and/or the applications 142A provide a sales region engine. A sales region engine 300 could also or instead be implemented within an online store to help regulate the resale of products from that online store. This online store may be the online store 138 of the e-commerce platform 100, for example, or be external to an e-commerce platform. The e-commerce platform 100 could include multiple sales region engines that are provided by one or more parties. The multiple sales region engines could be implemented in the same way, in similar ways and/or in distinct ways. In addition, at least a portion of a sales region engine could be implemented on the merchant device 102. For example, the merchant device 102 could store and run the sales region engine locally as a software application.

The sales region engine 300 could implement at least some of the functionality described herein. Although the embodiments described below may be implemented in association with an e-commerce platform, such as (but not limited to) the e-commerce platform 100, the embodiments described below are not limited to the specific e-commerce platform 100 of FIGS. 1 to 3. Further, the embodiments described herein do not necessarily need to be implemented in association with or involve an e-commerce platform at all. The embodiments described herein may be more generally implemented by any system, device and/or computing platform related to online shopping.

### Example Sales Regions for an Online Store

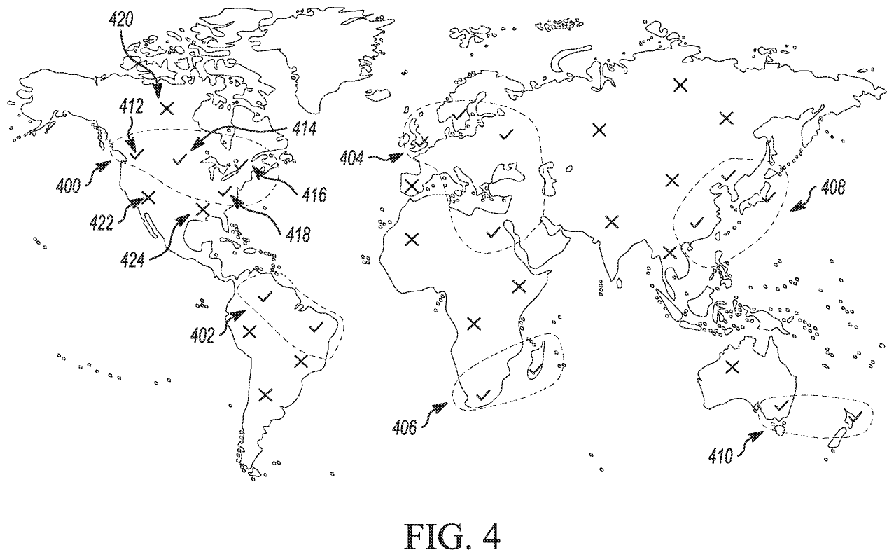

FIG. 4 is a map illustrating multiple sales regions 400, 402, 404, 406, 408, 410 for a particular product sold through an online store by a merchant, according to an embodiment. The geographic boundaries or delineation of each of the sales regions 400, 402, 404, 406, 408, 410, shown using dashed lines in FIG. 4, may also be referred to as a geofence.

The sales regions 400, 402, 404, 406, 408, 410 generally correspond to the customer base for the product and, in some cases, may correspond to the customer base for the merchant. Each of the sales regions 400, 402, 404, 406, 408, 410 includes multiple geographic locations, shown using check marks, where the product has a relatively large customer base and/or high market success. Geographic locations where the product has a relatively small customer base and/or low market success, shown using x-marks, are generally excluded from the sales regions 400, 402, 404, 406, 408, 410. By way of example, the sales region 400 is defined to include locations 412, 414, 416, 418 that have a strong customer base for the product, and to exclude locations 420, 422, 424 that have a weak or no customer base for the product. The locations 412, 414, 416, 418, 420, 422, 424 may correspond to buildings, streets, cities, counties, provinces, states and/or any other type of geographic region. It should be noted that the locations 412, 414, 416, 418, 420, 422, 424 are only examples, and the region 400 may also be defined based on additional locations that are not shown in FIG. 4.

As illustrated in FIG. 4, sales regions 400, 402, 404, 406, 408, 410 are not limited to any particular shape, and may generally be drawn in any form to capture the customer base of the product. Furthermore, the shape and number of the sales regions 400, 402, 404, 406, 408, 410 may change dynamically over time responsive to changes to the customer base for the associated product. As noted above, the customer base for a product sold online may change rapidly, and therefore sales regions 400, 402, 404, 406, 408, 410 should also be redefined and/or updated rapidly in response.

### Example Systems and Methods for Defining Sales Regions

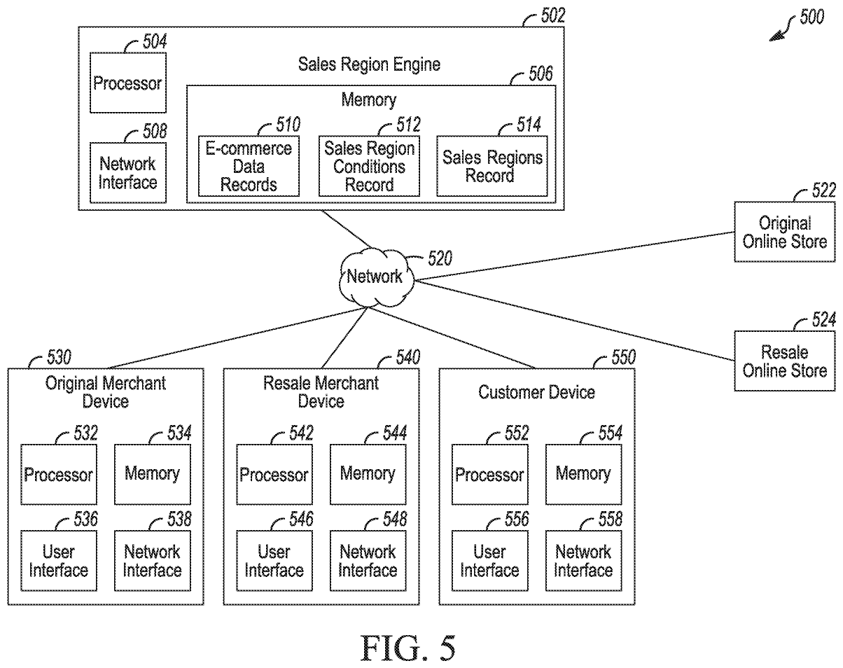

FIG. 5 is a block diagram illustrating an example system 500 for defining sales regions. The system 500 includes a sales region engine 502, a network 520, an original online store 522, a resale online store 524, an original merchant device 530, a resale merchant device 540 and a customer device 550.

In some implementations, the original online store 522 is owned and/or operated by an original merchant that sells a particular product and the resale online store 524 is owned and/or operated by a resale merchant that resells that same product. For example, the original merchant may be the designer and/or manufacturer of the product. The resale merchant may purchase the product from the original merchant through B2B wholesale selling, for example, and then resell the product using the resale online store 524. The resale merchant may have a different customer base than the original merchant, allowing the resale merchant to increase the overall number of sales of the product.

Either or both of the original online store 522 and the resale online store 524 may be hosted on a server. In some implementations, the original online store 522 and/or the resale online store 524 may be hosted by an e-commerce platform. For example, the original online store 522 and/or the resale online store 524 may be similar to the online store 138 of FIG. 1.

It should be noted that the terms “original” and “resale” are not intended to be limiting herein. For example, although the original merchant may design and/or manufacture at least one product, the original merchant may also purchase other products for resale through the original online store 522. Similarly, although the resale merchant resells at least one product, the resale merchant may also design and/or manufacture their own products for sale through the resale online store 524.

The original merchant device 530 and the resale merchant device 540 are examples of user devices, The original merchant device 530 may be associated with (for example, owned and/or used by) the original merchant of the original online store 522, and the resale merchant device 540 may be associated with the resale merchant of the resale online store 524. In some implementations, the original merchant device 530 may be used to manage the original online store 522 and the resale merchant device 540 may be used to manage the resale online store 524. Either or both of the original merchant device 530 and the resale merchant device 540 may be a mobile phone, tablet, laptop or computer.

The customer device 550 is an example of a device that is associated with a customer. The customer device 550 may be a mobile phone, tablet, laptop or computer owned and/or used by the customer. Using the customer device 550, the customer may visit, navigate and/or purchase products from the original online store 522 and/or the resale online store 524. When visiting the original online store 522 and/or the resale online store 524, the customer may be signed-on to an account with these stores.

As illustrated, the original merchant device 530 includes a processor 532, memory 534, user interface 536 and network interface 538. The resale merchant device 540 also includes a processor 542, memory 544, user interface 546 and network interface 548. Further, the customer device 550 includes a processor 552, memory 554, user interface 556 and network interface 558. The original merchant device 530 will be described by way of example below. However, it should be noted that either or both of the resale merchant device 540 and the customer device 550 may be implemented in the same or a similar way.

An example of the user interface 536 is a display screen (which may be a touch screen), a gesture recognition system, a keyboard, and/or a mouse. The network interface 538 is provided for communicating over the network 520. The structure of the network interface 538 will depend on how the original merchant device 530 interfaces with the network 520. For example, if the original merchant device 530 is a mobile phone or tablet, the network interface 538 may include a transmitter/receiver with an antenna to send and receive wireless transmissions to/from the network 520. If the original merchant device 530 is a personal computer connected to the network with a network cable, then the network interface 538 may include, for example, a NIC, a computer port, and/or a network socket. The processor 532 directly performs or instructs all of the operations performed by the original merchant device 530. Examples of these operations include processing user inputs received from the user interface 536, preparing information for transmission over the network 520, processing data received over the network 520, and instructing a display screen to display information. The processor 532 may be implemented by one or more processors that execute instructions stored in the memory 534. Alternatively, some or all of the processor 532 may be implemented using dedicated circuitry, such as an application specific integrated circuit (ASIC), a graphics processing unit (GPU) or a programmed field programmable gate array (FPGA).

In FIG. 5, the number of merchant devices and customer devices are shown by way of example. Any number of merchant devices and customer devices may be implemented in the system 500. In addition, any number of online stores may be implemented in the system 500.

The network 520 may be a computer network implementing wired and/or wireless connections between different devices, including the sales region engine 502, a server hosting the original online store 522, a server hosting the resale online store 524, the original merchant device 530, the resale merchant device 540 and the customer device 550, for example. The network 520 may implement any communication protocol known in the art. Non-limiting examples of communication protocols include a local area network (LAN), a wireless LAN, an internet protocol (IP) network, and a cellular network.

The sales region engine 502 stores and analyses e-commerce data to dynamically define sales regions for one or more products sold by merchants, including but not limited to the original merchant of the original online store 522 and the resale merchant of the resale online store 524. The sales region engine 502 includes a processor 504, memory 506 and a network interface 508. The processor 504 may be implemented by one or more processors that execute instructions stored in the memory 506 or in another non-transitory computer readable medium. These instructions could implement any method described herein. Alternatively, some or all of the processor 504 may be implemented using dedicated circuitry, such as an ASIC, a GPU, or a programmed FPGA.

The network interface 508 is provided for communication over the network 520. The structure of the network interface 508 is implementation specific. For example, the network interface 508 may include a network interface card (NIC), a computer port (for example, a physical outlet to which a plug or cable connects), and/or a network socket.

As illustrated, the memory 506 stores multiple e-commerce data records 510, a sales region conditions record 512, and a sales region record 514.

The multiple e-commerce data records 510 include e-commerce data pertaining to one or more products sold online. The e-commerce data may also more generally pertain to the merchant(s) that sell those products. These merchants may be original merchants and/or resale merchants of the products. For a particular product sold by a merchant, the e-commerce data records 510 may provide information relating to, inter alia:
Sales of the product, including the number of sales and total revenue from the sales, for example.
Advertisement of the product, such as an advertising spend or an advertising budget, for example.
Online store traffic associated with the product, including product page views in an online store, the amount of time customers spend viewing the product page, social media shares of the product page and search results that match the product page, for example.
Shipping costs for the product to one or more locations.

Each data record in the e-commerce data records 510 may pertain to one or more different geographic locations and/or to one or more periods of time. These different geographic locations and periods of time may be defined at any of a number of different levels of granularity. In one example, an e-commerce data record includes an indication that one customer residing in a particular geographic location has purchased a product from a merchant's online store at a particular time. The customer's geographic location may be determined in a variety of manners, For example, the customer's geographic location could be determined based on the shipping address, billing address and/or another known address for the customer. In another example, an e-commerce data record includes an indication that a particular advertising budget has been allocated to one or more geographic locations for the course of a year. In a further example, an e-commerce data record includes an indication that one customer residing in a particular geographic location is searching for and/or viewing a product page in an online store at a particular time. The geographic location of this customer may be determined based on the internee protocol (IP) address of the customer or, if the customer is signed-on to their account in the online store, a stored billing address or shipping address for the customer. In yet another example, an e-commerce data record includes the cost of shipping a product to a customer in a particular location.

In some implementations, at least some e-commerce data stored in the e-commerce data records 510 is obtained from online stores, such as the original online store 522 and/or the resale online store 524, for example. Sales data, advertisement spend, product page traffic and/or shipping data for any, some or all products sold in an online store could be recorded and transmitted to the sales region engine 502 for storage in the e-commerce data records 510. E-commerce data may also or instead be obtained from an e-commerce platform. For example, at least a portion of the data stored in the data facility 134 of the e-commerce platform 100 of FIG. 1 may be provided to the sales region engine 502 for storage in the e-commerce data records 510. Further, e-commerce data may be provided through direct merchant input using, for example, the original merchant device 530 and/or the resale merchant device 540.

E-commerce data may be only temporarily stored in the e-commerce data records 510 before and/or during analysis by the sales region engine 502. However, the e-commerce data records 510 could also provide a permanent or semi-permanent record of e-commerce data.

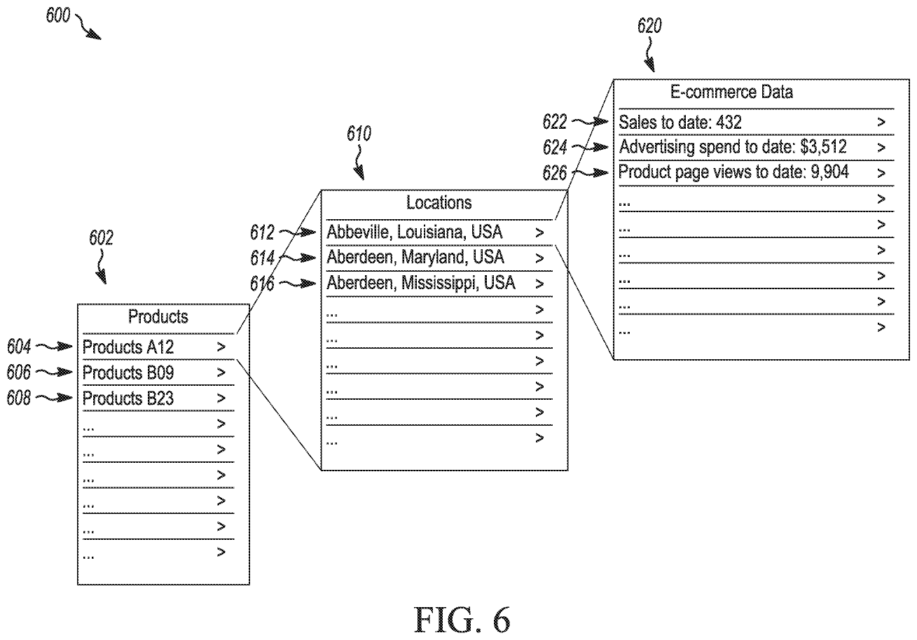

FIG. 6 illustrates an example data structure 600 for storing multiple e-commerce data records. The data structure 600 may be implemented within the memory 506 to store the e-commerce data records 510 of FIG. 5, for example. The data structure 600 includes a list 602 of multiple products 604, 606, 608 that are sold in one or more online stores. Additional products may also be included in the list 602. E-commerce data records for each of the products 604, 606, 608 are organized by geographic location in the data structure 600. By way of example, the data structure 600 includes a list 610 of multiple different cities 612, 614, 616 associated with one or more e-commerce data records for the product 604. Additional geographic locations may also be included in the list 610.

A list 620 of e-commerce data for the product 604 and the city 612 is shown by way of example in FIG. 6. The list 620 includes an indication 622 of the total sales of the product 604 in the city 612, an indication 624 of the total advertising spend for the product 604 in the city 612, and an indication 626 of the total online store traffic for the product 604 in the city 612. Additional e-commerce data may also be stored within the list 620, including temporal data and/or customer demographic for sales, advertising spend and online store traffic. By way of example, the date of each sale of the product 604 in the city 612 and/or the age of the customer associated with each sale of the product 604 in the city 612 may be stored within the data structure 600.

The data structure 600 is only one example of how e-commerce data records may be stored in memory. In general, e-commerce data records may be stored in any form of list, array (of any dimension) and/or data tree, for example.

Referring again to FIG. 5, the sales region conditions record 512 includes a list or set of defined conditions that are used to qualify or otherwise assess the strength of a customer base for a particular product sold by a merchant. These defined conditions generally provide an indication that a product has or is gaining market success in a geographic location. For example, a product meeting one or more of the defined conditions in a geographic location could indicate that the product has an established or growing customer base in that location. A defined condition may be defined in terms of, inter cilia, sales of a product, advertisement of the product, online store traffic associated with the product, shipping costs for the product, or any combination thereof.

In some implementations, the defined conditions stored in the sales region conditions record 512 include a threshold number of sales, a threshold advertising spend and/or a threshold level of online store traffic for a product. These thresholds may be expressed in terms of per-capita values, in order to avoid unfairly prejudicing geographic locations with lower populations. A defined condition may also include a threshold cost to ship the product to a geographic location.

In some implementations, the defined conditions stored in the sales region conditions record 512 are defined in terms of e-commerce data trends. For example, a defined condition may include a threshold for growth in number of sales, advertising budget and/or level of online store traffic for a product.

Non-limiting examples of defined conditions that may be stored in the sales region condition record 512 include:
Number of sales per unit time such as, for example, 1,000 sales in a month;
Per-capita sales per unit time such as, for example, 100 sales per million people in a month;
Sales growth rate per unit time such as, for example, a sales growth rate of 5% in a month;
Value of advertising spend per unit time such as, for example, $1,000 advertising spend in a month;
Per-capita value of advertising spend per unit time such as, for example, $100 advertising spend per million people in a month;
Advertising spend growth rate per unit time such as, for example, an advertising spend growth rate of 5% in a month;
Number of online resource views per unit time such as, for example, 10,000 online product page views in a month;
Per-capita online resource views per unit time such as, for example, 1,000 online product page views per million people in a month; and
Online resource views growth rate per unit time such as, for example, a growth rate of 5% for online product page views in a month.

Defined conditions for sales regions may also be based on data other than e-commerce data. For example, a defined condition may include the presence or absence of brick-and-mortar retail stores in a geographic region. If a merchant owns or otherwise utilizes a retail store to sell a product in a geographic location, then this geographic location may meet a defined condition for the product.

The sales region record 514 identifies one or more sales regions for products and/or merchants. At least some of the sales regions stored in the sales region record 514 may correspond to products sold in the original online store 522 and/or in the resale online store 524. FIG. 4 provides examples of sales regions for a product that may be identified in the sales region record 514.

As discussed in further detail elsewhere herein, a sales region stored within the sales region record 514 may be defined using a list or set of geographic locations that meet at least one of the defined conditions stored in the sales region conditions record 512. For example, a sales region stored within the sales region record 514 may be defined by geographic boundaries that are drawn to include the geographic locations that meet the at least one defined condition and to exclude other geographic locations that do not meet the at least one defined condition for the product. The geographic locations that are used to define sales regions may be delineated at any level of granularity, including but not limited to building, street, city, county, province, state, country and continent.

The sales regions identified within the sales region record 514 may be used for any of a variety of purposes. In some cases, the sales region record 514 is used to determine where resale of a product should be restricted. For example, the sales region engine 502 may recommend that resale of a product be restricted at any location that falls within an identified sales region for that product. Restricting resale of a product within a sales region is discussed in further detail elsewhere herein.

The sales region engine 502 is provided by way of example. Other implementations of a sales region engine are also contemplated. In some implementations, a sales region engine is provided at least in part by an e-commerce platform, either as a core function of the e-commerce platform or as an application or service supported by or communicating with the e-commerce platform. In some implementations, a sales region engine is implemented at least in part by a user device, such as a customer device or a merchant device. In some implementations, a sales region engine is implemented as a stand-alone service to generate AR content. While the sales region engine 502 is shown as a single component, a sales region engine could instead be provided by multiple different components that are in communication via a network.

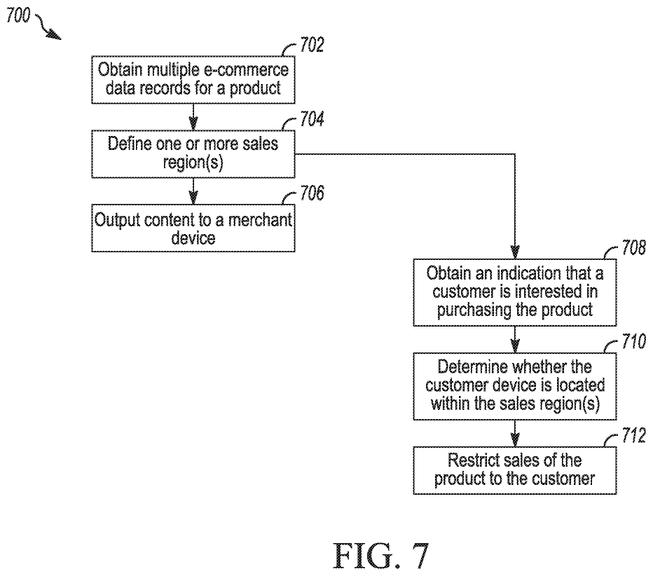

FIG. 7 is a flow diagram illustrating a method 700 for dynamically defining one or more sales regions for a product, according to an embodiment. The method 700 will be described as being performed by the sales region engine 502 of FIG. 5. However, other implementations are also contemplated. For example, the method 700 could be performed in whole or in part by the original online store 522, the resale online store 524, the original merchant device 530 and/or the resale merchant device 540.

Step 702 includes the processor 504 obtaining multiple e-commerce data records for a product offered for sale in the original online store 522 by the original merchant. Each e-commerce data record pertains to at least one geographic location, and may relate to at least one of sales of the product, advertisement of the product and online store traffic associated with the product, for example. In some implementations, the e-commerce data records obtained in step 702. are at least some of the e-commerce data records 510 stored in the memory 506. Alternatively, or in addition, the e-commerce data records may be received from the original online store 522 and/or the original merchant device 530.

The e-commerce data records obtained in step 702 may be obtained all at once, but this might not always be the case. In some implementations, the e-commerce data records are obtained at different times. For example, the processor 504 may continuously or intermittently obtain new e-commerce data as it becomes available. If the product is sold to a customer through the original online store 522, then a new e-commerce data record including the details of the sale (for example, the time of the sale and the geographic location of the customer) could be generated and transmitted to the sales region engine 502.

It should be noted that the e-commerce data records obtained in step 702 may relate to sales of the product in other stores in addition to the original online store 522, including brick-and-mortar stores and/or other online stores.

Step 704 includes the processor 504 defining one or more sales region(s) for the product based on the e-commerce data records obtained in step 702. These sales region(s) may be defined to include geographic locations that meet at least one defined condition for the product. The sales region(s) may instead be defined to include geographic locations that meet multiple defined conditions for the product, such as at least two defined conditions, for example. Examples of sales regions that could be defined in step 704 are provided in FIG. 4.

The defined conditions used to define the sales region(s) in step 704 may be obtained from the sales region conditions record 512. For each geographic location, the processor 504 could compare the defined conditions stored in the sales region conditions record 512 to the e-commerce data records pertaining to that location. In some implementations, only recent e-commerce data (for example, e-commerce data relating to the last 7 days) is used to determine if any defined conditions are met by a geographic location. Therefore, over time, some geographic locations may no longer meet defined conditions that they previously met.

In some implementations, step 704 includes defining boundaries of one or more sales region(s) to include geographic locations that meet at least one defined condition for the product and to exclude other geographic locations that do not meet any defined conditions for the product. Algorithms (stored in the memory 506 or another computer readable medium) may be used to determine the boundaries of the sales region(s). As an example, geographic locations that meet at least one defined condition may each be treated as a data point on a map, and a clustering algorithm with thresholds may be used to define one or more sales region(s) from the data points. The thresholds can ensure that although every data point may be assigned a “most likely” cluster, the data point might still have to be within a certain distance of the others in the cluster (for example, the cluster's mean) to be considered part of a contiguous boundary of a sales region. Non-limiting examples of such clustering algorithms include K-means clustering, mean-shift clustering, density-based spatial clustering of applications with noise (DBSCAN), expectation-maximization (EM) clustering using gaussian mixture models (GMM), and agglomerative hierarchical clustering.

In some implementations, a merchant is permitted to select or alter the granularity of the sales region(s) defined in step 704. For example, a merchant may choose if sales regions are delineated by building, street, city, county, province, state, country or continent. If sales of a product in Brooklyn, N.Y., USA meet a defined condition, then sales region granularity may determine if the sales region includes Brooklyn, all of New York City, all of New York State, all of the USA (for example, if the merchant only wants resellers in other countries), or all of North America.

It should be noted that, although sales region(s) may be defined to include geographic locations that meet at least one defined condition for the product and to exclude other geographic locations that do not meet any defined conditions for the product, a sales region may still include locations that do not meet any defined conditions. This might be the case if a location that does not meet a defined condition is surrounded by other locations that do meet at least one defined condition, for example. Similarly, a location that does meet at least one defined condition might not be included in a sales region if the location is not near any other locations that meet a defined condition.

Sales region(s) may be dynamically defined in step 704. This may help accommodate the rapid changes in customer base that are possible through online shopping. Dynamically defining sales regions may include redefining or updating the boundaries of one or more sales region(s) responsive to obtaining new e-commerce data records in step 702. Dynamically defining sales regions may also or instead include adjusting a number of sales regions (for example, creating a new sales region or removing a sales region) responsive to obtaining new e-commerce data records in step 702. Defining sales regions responsive to obtaining new e-commerce data records may allow the sales regions to be defined in real-time and better reflect the current customer base of a product.

In some implementations, when a new e-commerce data record for a geographic location is received, the e-commerce data record may be added to a cumulative set of e-commerce data (for example, to the e-commerce data records 510). The cumulative set of e-commerce data may then be analyzed in step 704 to determine if there are any changes to the defined conditions that are met or not met by the geographic location. By way of example, the new e-commerce data record may indicate that a sale of the product was made in the geographic location. When this new sale of the product is added to the cumulative sales of the product over a period of time, the geographic location may meet a defined condition for a threshold number of product sales.

Any changes in the geographic locations that meet one or more defined conditions may result in corresponding changes to one or more of the sales regions defined in step 704. For example, the boundaries of a sales region may be updated to include or exclude a geographic location. The number of sales regions may also change. In an example, a new sales region may be defined to include a geographic location that has met a defined condition. In another example, a sales region may be removed if a geographic location in the sales region no longer meets a defined condition. In a further example, two separate sales regions could be combined into a single sales region when a new geographic location between the two sales regions meets a defined condition. In yet another example, a single sales region could be split into two separate sales regions when a geographic location between the two sales regions no longer meets a defined condition. These are examples of dynamically defining sales regions in response to obtaining new e-commerce data records.

In some implementations, the original merchant of the original online store 522 might want to avoid having sales regions change overly rapidly. For example, rapid changes to sales regions could be difficult to accommodate for a resale merchant that is purchasing the product from the original merchant. Therefore, defined conditions may implement hysteresis to avoid overly rapid changes to sales regions. Hysteresis may include implementing different thresholds when a geographic location is meeting a defined condition compared to when a geographic location is no longer meeting a defined condition. In an example, a threshold of 100 sales per week could be defined as a threshold for a geographic location to meet a defined condition. However, if the geographic location already meets the defined condition, then the geographic location might have to drop below 80 sales per week to no longer meet the defined condition. Implementing hysteresis in defined conditions is an example method for providing consistency in sales regions that are dynamically defined.

In addition to being defined in terms of geographic locations, a sales region may also be defined in terms of customer demographic in step 704. For example, e-commerce data may reveal that the original merchant of the original online store 522 has a strong customer base of younger customers in a geographic location, but a weak customer base of older customers in the same geographic location. Therefore, a sales region could be defined to include the younger customers in the geographic region and to not include the older customers in the geographic region.

The sales region(s) defined in step 704 may be stored in the memory 506 (for example, in the sales region record 514) or in some other computer readable medium. In some implementations, a merchant is permitted to add, remove or modify the sales regions for a product. For example, if the merchant wants to grow their business in a particular geographic location that is not included in a sales region, then the merchant may add this geographic location to an existing sales region or define a new sales region around this geographic location.

After defining one or more sales region(s) in step 704, the method 700 generally includes outputting content to a merchant device and/or to a customer device associated with another online store, such as the resale online store 524, for example. As discussed in further detail below, this content is based on the sales region(s) defined in step 704.

In some implementations, the method 700 performs optional step 706 which includes outputting content that is based on the sales region(s) defined in step 704 to the resale merchant device 540 and/or to another device associated with a resale merchant. This content may be generated by the processor 504 and transmitted to the resale merchant device 540 via the network 520, for example. The content may include an indication that resale of the product to customers located in the sales region(s) is restricted. For example, customers in the sales region(s) might not be permitted to purchase the product through the resale online store 524.

In some implementations, step 706 is performed responsive to obtaining a request from the resale merchant device 540, or another device, indicating that the resale merchant wishes to purchase the product from the original merchant. For example, the resale merchant may be interested in buying the product from the original merchant through B2B wholesale selling for resale in the resale online store 524. After generating a request to purchase the product from the original merchant using the resale merchant device 540, for example, the resale merchant may be provided with a map that depicts the sales region(s) determined in step 704 where resale of the product is restricted at that time. Using the map, the resale merchant may decide whether or not to purchase the product from the original merchant through B2B wholesale selling. If the resale merchant determines that their customer base overlaps significantly with the original merchant's sales region(s), and therefore the resale merchant would be restricted from selling the product to a significant portion of their customer base, then the resale merchant may decide not to purchase the product.

In some implementations, step 706 may further include automated operations related to determining if a resale merchant's customer base overlaps significantly with the sales region(s) determined in step 704. For example, step 706 may further include the processor 504 determining one or more sales region(s) associated with the resale online store 524. These sales region(s) may be defined using steps similar to steps 702, 704, and/or may be obtained from the sales region record 514, for example. Because the resale merchant might not be selling the same product as the original merchant, the sales regions for the resale online store 524 may be defined using similar products or similar product categories that are sold on the resale online store 524. Alternatively, the sales regions for the resale online store 524 could be defined based on all of the products sold on the resale online store 524, which may provide an indication of the resale merchant's overall customer base.

After obtaining the sales region(s) of the resale online store 524, the processor 504 may then determine the overlap between the sales regions of the product sold by the original merchant and the sales regions of the resale online store 524. This overlap may be determined in terms of a percentage, for example. In some cases, if the overlap exceeds a defined threshold, then the resale merchant might not be permitted to purchase the product from the original merchant. This provides one form of restricting resale of the original merchant's products within the sales region(s). If, on the other hand, the processor 504 determines that one or more sales region(s) for the resale online store 524 do not overlap with the sale region(s) of the original merchant's product, then the content output in step 706 may include an option for the resale merchant to purchase the product from the original merchant. In some cases, even if the resale merchant is permitted to purchase the product from the original merchant, then resale of the product may be limited to geographic locations that are outside of the sales region(s) determined in step 704.

In some implementations, step 706 may be implemented at least in part using a marketplace for B2B wholesale selling. This marketplace may include multiple products that are generally available for purchase through B2B wholesale selling. The marketplace may also dynamically define and/or store sales regions for each of these multiple products. In some cases, the B2B wholesale marketplace uses the sales region engine 502 or another sales region engine to define the sales regions. The sales regions may be implemented to help regulate B2B wholesale selling of each product to resale merchants through the marketplace. By way of example, using the resale merchant device 540, the resale merchant may generate a search query for a certain product or product type and transmit the search query to a B2B wholesale marketplace. Responsive to receiving the search query, the marketplace may generate a user interface for presentation on the resale merchant device 540 that includes a list of multiple products available for purchase through B2B wholesale selling which match the search query. This user interface may also indicate the sales regions for each product and/or the percentage of overlap between those sales regions and the resale merchant's sales regions. Further, the B2B wholesale marketplace may automatically filter products with sales regions that might be too restrictive for the resale merchant. As such, the user interface may display only products that are unlikely to have any significant sales region overlaps with the resale merchant.

In the case that the resale merchant purchases the product from the original merchant, the resale merchant may resell the product to customers outside of the sales region(s) determined in step 704. In such cases, optional steps 708, 710, 712 may be performed. Steps 708, 710, 712 may be performed after or in conjunction with step 706.

Step 708 includes obtaining, via the customer device 550, an indication that the customer is interested in purchasing the product from the resale online store 524. Such an indication could be generated by the customer using the customer device 550 to visit the resale online store 524, search for the product or a product category matching the product, and/or navigate to the product page corresponding to the product, for example.

Step 710 includes the processor 504 determining whether or not the customer and/or the customer device 550 is/are located within one of the sales regions determined in step 704. Step 710 may be performed in any of a number of different ways. In some implementations, the IP address of the customer device 550 is used to determine the location of the customer device 550. The customer's billing address and/or shipping address may also or instead be used to determine the location of the customer and/or the customer device 550. Either or both of these addresses may be stored in an account associated with the customer on the resale online store 524.

If step 710 determines that the customer and/or the customer device 550 is/are not located in any of the sales regions determined in step 704, then the customer may be permitted to purchase the product from the resale online store 524 and the method 700 may end. Alternatively, if step 710 determines that the customer and/or the customer device 550 is/are located in one of the sales regions determined in step 704, then step 712. may be performed in response.

Step 712 includes the processor 504 restricting sales of the product to the customer through the resale online store 524. In some implementations, step 712 includes or is achieved by outputting content to the customer device 550. This content may be generated by the processor 504 and transmitted to the customer device 550 via the network 520. The content may provide an explicit indication that sales of the product are restricted in the customer's geographic area. The indication could be in the form of a statement explaining that sales of the product are restricted, a checkout option on the product page being crossed-out or even removed, or shipment of the product being unavailable to the customer's geographic location. Alternatively, the content output to the customer device 550 might include an implicit indication that sales of the product are restricted. For example, the product page might not be available to the customer and/or the product might not show up in search queries generated by the customer. The content output for display on the customer device 550 may instead include an offer for sale of one or more other products excluding the product. These other products may be similar to the product sold by the original merchant.

Because the sales regions of the original merchant are dynamically determined, a customer in a particular location might be permitted to purchase the product from the resale merchant at one point in time and might not be permitted to purchase the product from the resale merchant at another point in time. As such, the availability of the product on the resale online store 524 may be updated in real-time, responsive to the sales region(s) for the original merchant being dynamically determined. This may capture real-time shifts in the original merchant's customer base and restrict the resale of the product to limit overlap with that customer base.

In some cases, the original merchant may permit a customer within a sales region to purchase the product from the resale online store 524. According to one example, the customer may be permitted to continue purchasing the product from the resale online store 524 if they have previously purchased the product from the resale merchant. Even if the original merchant's sales region(s) change to encompass the location of the customer, such a legacy customer might not be restricted from visiting the product page and purchasing the product from the resale online store 524. According to another example, the original merchant may permit a customer with a direct link to the product page on the resale online store 524 to purchase the product regardless of their location. This may allow product pages to be shared between customers, without the risk of blocking certain customers.

The order of steps 702, 704, 706, 708, 710, 712 are shown by way of example in FIG. 7. Other orders of steps 702, 704, 706, 708, 710, 712 are also contemplated. For example, step 708 may be performed before step 702 and/or step 704. Here, defining one or more sales region(s) for the product may be performed responsive to obtaining the indication that a customer is interested in purchasing the product. This may ensure that the sales regions are up-to-date and accurate when determining whether or not to allow the customer to purchase the product from the resale merchant.

### Further Examples

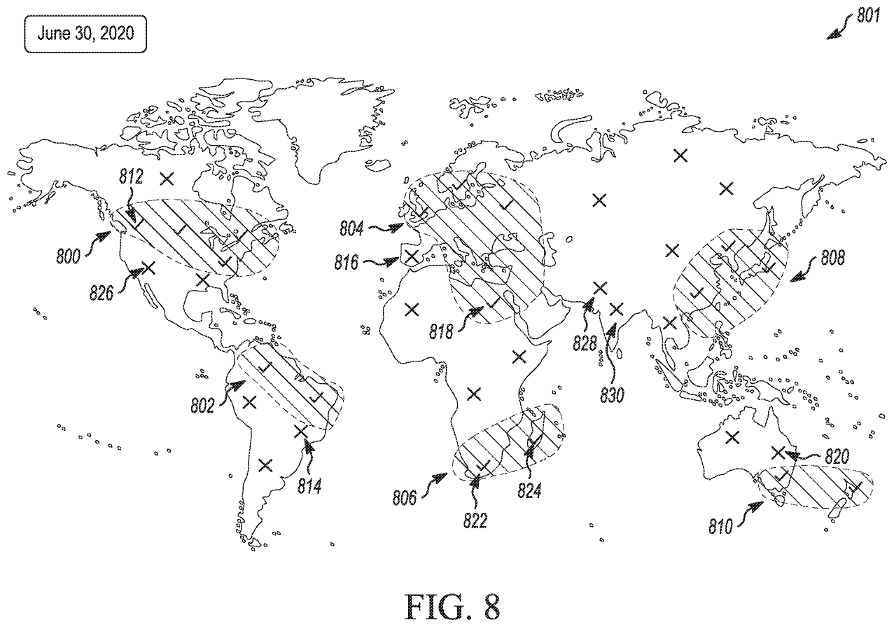

FIG. 8 is a map 801 illustrating multiple sales regions 800, 802, 804, 806, 808, 810 for a particular product sold through an online store by an original merchant, according to an embodiment. The sales regions 800, 802, 804, 806, 808, 810 shown in FIG. 8 correspond to a first instance in time (Jun. 30, 2020). The sales regions 800, 802, 804, 806, 808, 810 are generally defined to include locations that meet at least one defined condition for the product (shown using check marks). Locations 812, 818, 822, 824 are examples of locations that meet at least one defined condition for the product. Locations that do not meet any defined conditions for the product (shown using x-marks) are generally excluded from the sales regions 800, 802, 804, 806, 808, 810. Locations 814, 816, 820, 826, 828, 830 are examples of locations that do not meet at least one defined condition.

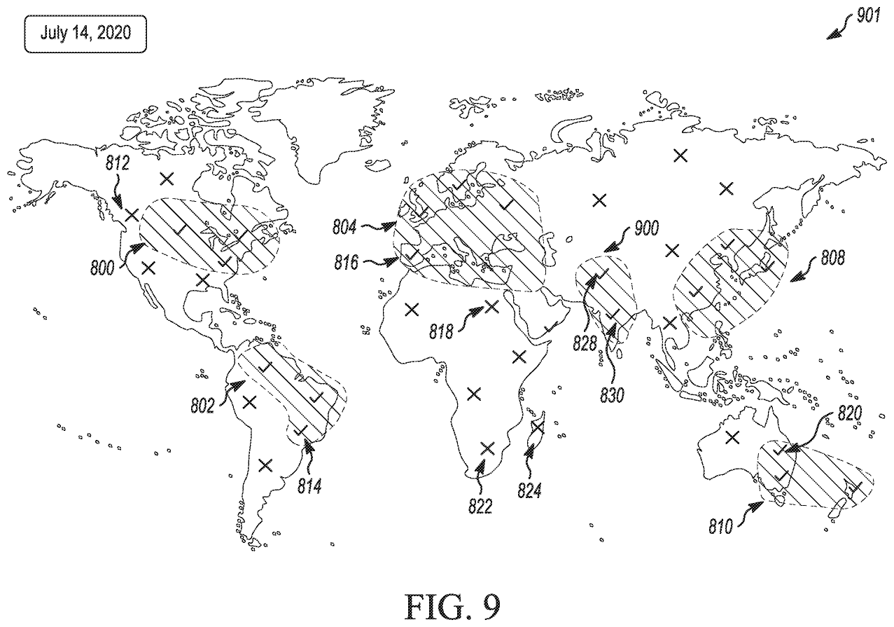

FIG. 9 is a map 901 illustrating the sales regions 800, 802, 804, 808, 810 of FIG. 8 at a second instance in time (Jul. 14, 2020). In FIG. 9, the sale regions 800, 802, 804, 810 have been updated or redefined based on changes to the locations that meet at least one defined condition for the product between the first instance in time and the second instance in time. At the second instance in time, the location 812 no longer meets a defined condition. As a result, the sales region 800 is redefined to exclude the location 812 in FIG. 9. Similarly, the sales region 804 is redefined to exclude the location 818 which no longer meets a defined condition. The location 814 does meet at least one defined condition at the second instance in time and the sales region 802 is redefined to include the location 814. Similarly, the sales regions 804, 810 are redefined to include the locations 816, 820, respectively, which meet at least one defined condition at the second instance in time.

As shown in FIG. 9, the locations 822, 824 do not meet at least one defined condition for the product at the second instance in time and the sales region 806 is removed as a result. A new sales region 900 is also defined at the second instance in time. The sales region 900 includes the locations 828, 830 which meet at least one defined condition at the second instance at time. The sales region 900 may have been defined because the locations 828, 830 are too far away from the sales regions 804, 808 to be included in these sales regions and/or because there are locations that do not meet at least one defined condition between the locations 828, 830 and the sales regions 804, 808.

It should be noted that not all sales regions are updated or redefined between the first instance in time and the second instance in time. The sales region 808, for example, remains substantially the same between the first instance in time and the second instance in time.

FIGS. 8 and 9 illustrate an example of dynamically defining sales regions for a product sold by an original merchant. In some implementations, the sales regions 800, 802, 804, 806, 808, 810, 900 are defined based on e-commerce data available at the first instance in time and the second instance in time. New e-commerce data that is obtained between the first instance in time and the second instance in time may result in the changes to the existence and boundaries of the sales regions 800, 802, 804, 806, 808, 810, 900. For example, between the first instance in time and the second instance in time, the boundaries of the sales regions 800, 802, 804, 810 are updated to reflect the changes to the customer base of the original merchant. The sales region 806 was also removed to reflect the possible decline of a previous customer base of the original merchant between the first instance in time and the second instance in time. Further, the sales region 900 was added to capture a potential new customer base of the original merchant that developed between the first instance in time and the second instance in time.

In some implementations, the sales regions 800, 802, 804, 806, 808, 810, 900 illustrated in FIGS. 8 and 9 are dynamically defined by a sales region engine in step 704 of the method 700. Further, the maps 801, 901 illustrated in FIGS. 8 and 9 may be included in content that is output by the sales region engine to a resale merchant device in step 706 of the method 700. This content may provide the resale merchant with an indication of where resale of the original merchant's product is restricted at the first and second instances in time, and help the resale merchant determine whether or not to purchase the product from the original merchant.

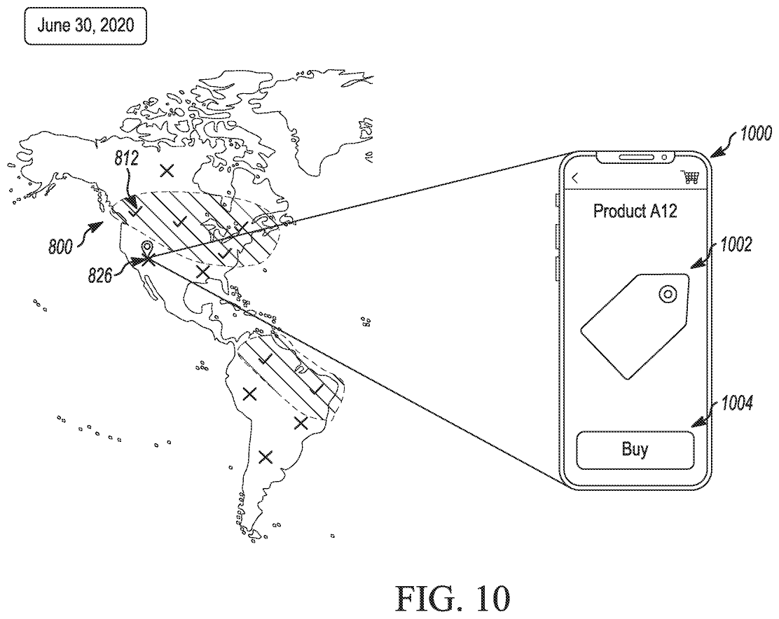

FIG. 10 illustrates a screen page 1002 displayed on a customer device 1000 that is in the location 826 at the first instance in time. The screen page 1002 corresponds to a product page in the online store of a resale merchant. The resale merchant has purchased the original merchant's product (“product A12”) that is associated with the sales regions 800, 802, 804, 806, 808, 810 of FIG. 8, and the screen page 1002 offers this product for sale. The resale merchant may have purchased the product from the original merchant through B2B wholesale selling under the condition that resale of the product in the original merchant's sales regions are restricted.

Because the customer device 1000 is within the location 826 at the first instance in time, the customer associated with the customer device 1000 may not be considered part of the original merchant's customer base for the product and is permitted to purchase the product from the resale merchant. As such, the screen page 1002 includes an option 1004 for the customer to purchase the product through the online store of the resale merchant. Allowing the customer to purchase the product from the resale merchant at the first instance in time may increase the total sales of the product without causing competition between the original merchant and the resale merchant.

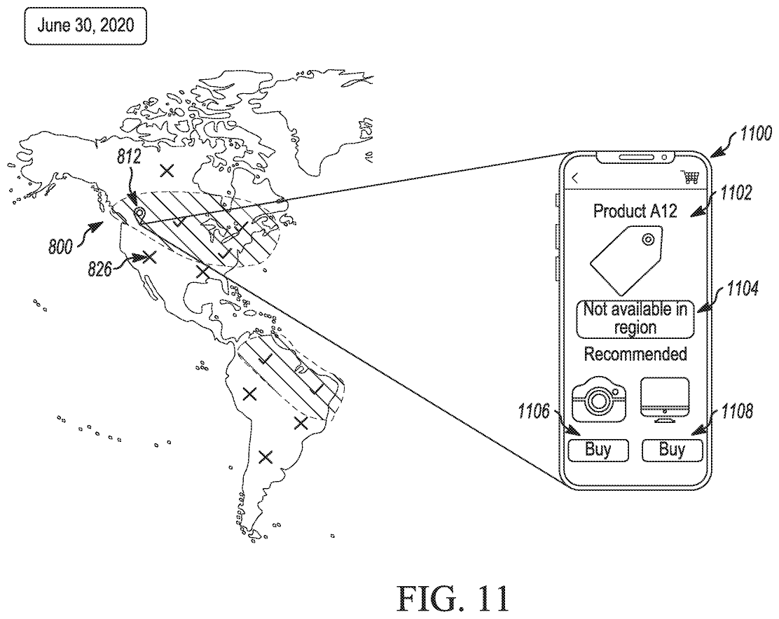

FIG. 11 illustrates a screen page 1102 displayed on a customer device 1100 that is in the location 812 at the first instance in time. The screen page 1102 corresponds to the same product page of the resale merchant as the screen page 1002. However, because the customer device 1100 is located within the sales region 800 of the original merchant at the first instance in time, the screen page 1102 includes an indication 1104 that the product is not available for purchase. Instead, the screen page 1102 includes multiple options 1106, 1108 to purchase other products sold in the online store of the resale merchant. In some implementations, the screen page 1102 forms some or all of the content that is output to a customer device in step 712 of the method 700.

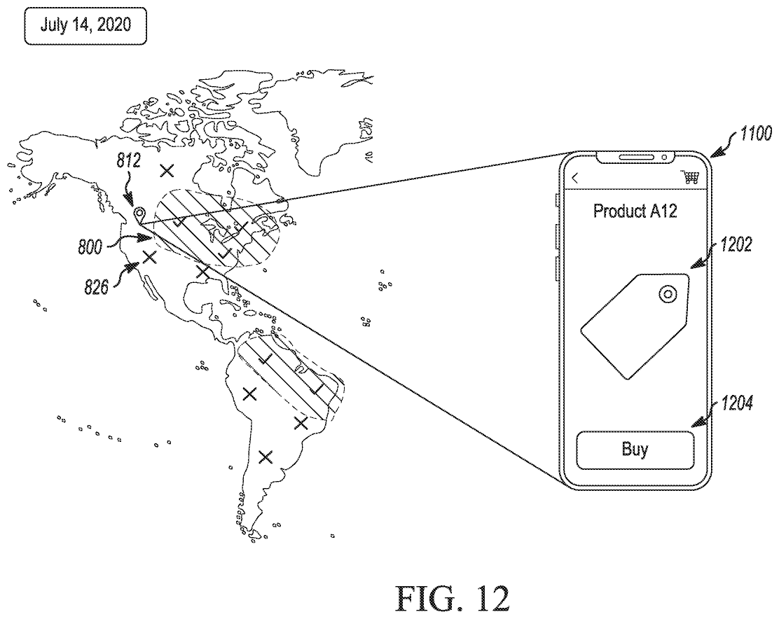

FIG. 12 illustrates a screen page 1202 displayed on the customer device 1100 that is in the location 812 at the second instance in time. The screen page 1202 also corresponds to the same product page of the resale merchant as the screen page 1002. As noted above, the location 812 is not included in the sales region 800 at the second instance in time. Accordingly, the screen page 1202 includes an option 1204 to purchase the product.

FIGS. 10 to 12 illustrate how dynamically defining sales regions may provide dynamic changes in the customers that are permitted to purchase products through a resale merchant. In this way, dynamically defining sales regions may better accommodate the geographic flexibility and rapid changes in the customer base that are enabled through online shopping.

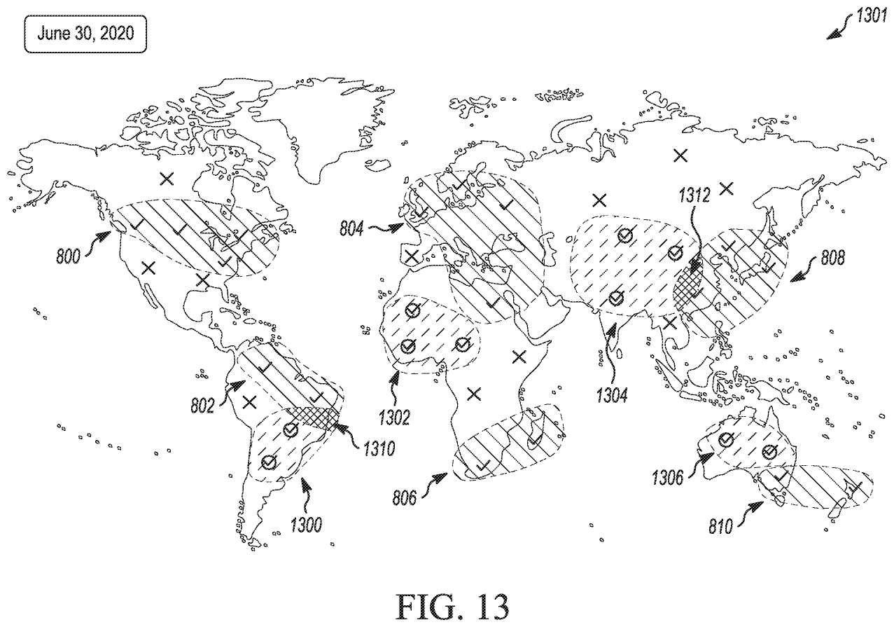

FIG. 13 is a map 1301 illustrating the sales regions 800, 802, 804, 806, 808, 810 of the original merchant at the first instance in time and sales regions 1300, 1302, 1304, 1306 of a resale merchant at the first instance in time. The sales regions 1300, 1302, 1304, 1306 are defined to include locations that meet at least one defined condition for the resale merchant (shown using a circled check marks). In some implementations, the defined conditions for the resale merchant are based on e-commerce data for one or more products sold online by the resale merchant. These products may be similar to the original merchant's product associated with the sales regions 800, 802, 804, 806, 808, 810, in order to compare the customer bases of the original merchant and the resale merchant in a similar product context.

The map 1301 further illustrates multiple overlap regions 1310, 1312 where the customer base of the resale merchant coincides with the customer base of the original merchant. The overlap region 1310 is formed by partial overlap of the sales region 802 and the sales region 1300, and the overlap region 1312 is formed by partial overlap of the sales region 808 and the sales region 1304.

The map 1301 is a further example of content that may be output to a resale merchant device in step 706 of the method 700 to provide the resale merchant with an indication of where resale of the original merchant's product is restricted. For example, the resale merchant may use the map 1301 to determine whether or not to purchase the original merchant's product. The overlap regions 1310, 1312 may indicate the areas where the resale merchant is not permitted to resell the product. If the resale merchant feels that the overlap regions 1310, 1312 represent too large a proportion of their customer base, then the resale merchant may decide not to purchase the item.

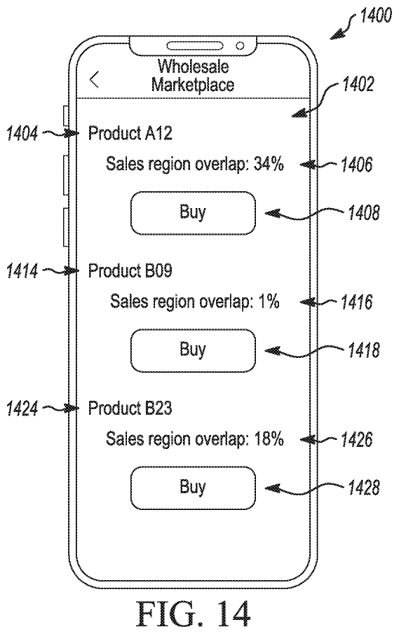

FIG. 14 illustrates a resale merchant device 1400 displaying a screen page 1402. The screen page 1402 corresponds to a B2B wholesale marketplace that helps facilitate wholesale selling between original merchants and resale merchants. The screen page 1402 includes multiple indications 1404, 1414, 1424 of respective products that the resale merchant associated with the resale merchant device 1400 may purchase through B2B wholesale selling. The screen page 1402 also includes multiple indications 1406, 1416, 1426 of sales region overlap for the products indicated at 1404, 1414, 1424, respectively. The indications 1406, 1416, 1426 identify the overlap between the sales regions of the resale merchant and sales regions of the original merchant for each of the products. For example, the indication 1406 identifies that 34% of the resale merchant's sales regions overlap with the sales regions of the original merchant for “Product A12”. Therefore, the resale merchant may be restricted from reselling this product to 34% of their customer base. The screen page 1402 further includes multiple options 1408, 1418, 1428 to purchase the products indicated at 1404, 1414, 1424, respectively.

The screen page 1402 is yet another example of content that may indicate the sales region(s) of an original merchant's product and that may help a resale merchant decide whether or not to purchase a product from the original merchant. In some implementations, the screen page 1402 is generated and transmitted to the resale merchant device 1400 following a search query generated using the resale merchant device 1400 and transmitted to the B2B wholesale marketplace. The products indicated at 1404, 1414, 1424 may match this search query. In some cases, the products indicated at 1404, 1414, 1424 may be a subset of the products that match the search query. The other products may have been automatically filtered out for having too high a sales region overlap with the resale merchant, and therefore the resale merchant is not provided with an option to purchase these other products.

### CONCLUSION

Although the present invention has been described with reference to specific features and embodiments thereof, various modifications and combinations may be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations may be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A computer-implemented method comprising:
obtaining, at different times, multiple e-commerce data records for a product offered for sale in a first online store, each data record pertaining to at least one respective geographic location and indicating that said product was purchased from said first online store at the at least one respective geographic location;
dynamically defining a region based on the multiple e-commerce data records, the region comprising a set of said geographic locations that meet at least one defined condition for the product, wherein dynamically defining the region comprises defining the region responsive to the obtaining the multiple e-commerce data records; and
outputting content to a device associated with a second online store, the content being based on the region and comprising an indication of whether the product can be purchased from the first online store using the device associated with the second online store.

2. The computer-implemented method of claim 1, wherein dynamically defining the region comprises dynamically defining boundaries of the region to include the geographic locations that meet the at least one defined condition for the product and to exclude other geographic locations that do not meet the at least one defined condition for the product.

3. The computer-implemented method of claim 2, wherein
defining the region responsive to obtaining the at least one of the multiple e-commerce data records comprises updating the boundaries of the region responsive to obtaining the at least one of the multiple e-commerce data records.

4. The computer-implemented method of claim 1, further comprising:
dynamically defining a plurality of regions, including the region, based on the multiple e-commerce data records,
wherein the content is further based on the plurality of regions.

5. The computer-implemented method of claim 4, wherein
defining the region responsive to obtaining the at least one of the multiple e-commerce data records comprises adding the region to the plurality of regions responsive to obtaining the at least one of the multiple e-commerce data records.

6. The computer-implemented method of claim 1, wherein:
the device is associated with a merchant of the second online store; and
the content further comprises an indication that sales of the product to customers located in the region are restricted.

7. The computer-implemented method of claim 1, wherein the device is associated with a customer of the second online store, the method further comprising:
obtaining, via the device, an indication that the customer is interested in purchasing the product from the second online store; and
determining that the device is located within the region,
wherein outputting the content to the device comprises restricting sales of the product to the customer, the restricting being responsive to determining that the device is located within the region.

8. The computer-implemented method of claim 7, wherein restricting the sales of the product to the customer comprises generating the content to include an offer for sale of one or more other products excluding the product.

9. The computer-implemented method of claim 7, wherein dynamically defining the region is done responsive to obtaining the indication.

10. The computer-implemented method of claim 1, wherein the device is associated with a merchant of the second online store and outputting the content to the device comprises:
identifying one or more sales regions associated with the second online store;
determining that the one or more sales regions do not include the region and;
obtaining a request via the device;
wherein outputting the content to the device is done responsive to said obtaining the request via the device and the content further comprises an option for the merchant of the second online store to purchase the product from a merchant of the first online store, after which the product is available to the merchant of the second online store to be resold outside of the region.

11. The computer-implemented method of claim 1, wherein each of the e-commerce data records relates to at least one of:
sales of the product;
advertisement of the product; and
online store traffic associated with the product.

12. A system comprising:
memory to store multiple e-commerce data records for a product offered for sale in a first online store, each data record pertaining to at least one respective geographic location and indicating that said product was purchased from said first online store at the at least one respective geographic location; and
at least one processor configured to:
obtain the multiple e-commerce data records at different times;
dynamically define a region based on the multiple e-commerce data records, the region comprising a set of said geographic locations that meet at least one defined condition for the product, wherein the region is dynamically defined responsive to the obtaining the multiple e-commerce data records; and
output content to a device associated with a second online store, the content being based on the region and comprising an indication of whether the product can be purchased from the first online store using the device associated with the second online store.

13. The system of claim 12, wherein the at least one processor is further configured to dynamically define boundaries of the region to include the geographic locations that meet the at least one defined condition for the product and to exclude other geographic locations that do not meet the at least one defined condition for the product.

14. The system of claim 13, wherein the at least one processor is further configured to
update the boundaries of the region responsive to obtaining the at least one of the multiple e-commerce data records.

15. The system of claim 12, wherein the at least one processor is further configured to dynamically define a plurality of regions, including the region, based on the multiple e-commerce data records,
wherein the content is further based on the plurality of regions.

16. The system of claim 15, wherein the at least one processor is further configured to
adjust a number of regions in the plurality of regions responsive to obtaining the at least one of the multiple e-commerce data records.

17. The system of claim 12, wherein:
the device is associated with a merchant of the second online store; and
the content further comprises an indication that sales of the product to customers located in the region are restricted.

18. The system of claim 12, wherein the device is associated with a customer of the second online store and the at least one processor is further configured to:
obtain, via the device, an indication that the customer is interested in purchasing the product from the second online store;
determine that the device is located within the region; and
restrict sales of the product to the customer responsive to determining that the device is located within the region.

19. The computer-implemented method of claim 18, wherein the at least one processor is further configured to generate the content to include an offer for sale of one or more other products, excluding the product, to restrict the sales of the product to the customer.

20. The system of claim 18, wherein the at least one processor is further configured to dynamically define the region responsive to obtaining the indication.

21. The system of claim 12, wherein the device is associated with a merchant of the second online store and when outputting the content to the device the at least one processor is further configured to:
identify one or more sales regions associated with the second online store;
determine that the one or more sales regions do not include the region;
obtain a request via the device; and
output the content to the device responsive to said obtaining a-the request via the device, wherein the content further comprises an option for the merchant of the second online store to purchase the product from a merchant of the first online store, after which the product is available to the merchant of the second online store to be resold outside of the region.

22. The system of claim 12, wherein each of the e-commerce data records relates to at least one of:
sales of the product;
advertisement of the product; and
online store traffic associated with the product.

23. A non-transitory computer readable medium storing computer executable instructions which, when executed by a computer, cause the computer to perform a method, the method comprising:
obtaining, at different times, multiple e-commerce data records for a product offered for sale in a first online store, each data record pertaining to at least one respective geographic location and indicating that said product was purchased from said first online store at the at least one respective geographic location;
dynamically defining a region based on the multiple e-commerce data records, the region comprising a set of said geographic locations that meet at least one defined condition for the product, wherein dynamically defining the region comprises defining the region responsive to the obtaining the multiple e-commerce data records; and
outputting content to a device associated with a second online store, the content being based on the region and comprising an indication of whether the product can be purchased from the first online store using the device associated with the second online store
